(19) United States
(12) Patent Application Publication
(10) Pub. No.: US 2025/0103880 A1
(43) Pub. Date: Mar. 27, 2025

(54) LEARNING METHOD AND DEVICE FOR GENERATIVE ARTIFICIAL INTELLIGENCE MODEL

(71) Applicant: Superngine Co., Ltd., Seongnam-si (KR)

(72) Inventors: Chul Soo LIM, Paju-si (KR); Dong Jun KIM, Anyang-si (KR)

(73) Assignee: Superngine Co., Ltd., Seongnam-si (KR)

(21) Appl. No.: 18/516,495

(22) Filed: Nov. 21, 2023

(30) Foreign Application Priority Data
Sep. 26, 2023 (KR) 10-2023-0128956

(51) Int. Cl. G06N 3/08

(52) U.S. Cl. CPC G06N 3/08

(57) ABSTRACT

Disclosed are a learning method and device for a generative artificial intelligence model. The learning method includes collecting original data of an artist; preparing valid data by removing noise from the original data; performing a first style learning operation of distinguishing and learning color information and line information among the valid data; and generating a first bias model by merging training data derived from the first style learning operation again.

### CROSS-REFERENCE TO RELATED APPLICATIONS

A claim for priority under 35 U.S.C. § 119 is made to Korean Patent Application No. 10-2023-0128956 filed on Sep. 26, 2023 in the Korean Intellectual Property Office, the entire contents of which are hereby incorporated by reference.

### BACKGROUND

Embodiments of the inventive concept described herein relate to a learning method and device for a generative artificial intelligence model, and more particularly, relate to a learning method and device for a generative artificial intelligence model that may be used as a more predictable tool by ensuring the consistency of the output data output from the generative artificial intelligence model.

Recently, many people create pictures through a diffusion model, which is a generative artificial intelligence model, without drawing pictures directly. Such a diffusion model has a massive amount of learning, and additional training data of various people is applied through open source policies. Accordingly, the quality of an image generated through a diffusion model is increasingly sophisticated.

However, when such a generative artificial intelligence model creates a plurality of images, the generative artificial intelligence model only randomly generates various images and does not generate consistent images as the user intended. Therefore, the user must make numerous attempts to obtain a desired image.

In addition, the comics market has grown as people's demand for webtoons, which are digital comics serialized online as well as comics serialized offline, has recently increased. In general, writers who serialize webtoons produce webtoons at a certain cycle (e.g., once a week, twice a week, or the like) and upload them online. Recently, as the webtoon market has grown, the expectations of general consumers regarding the quality of webtoons have also increased, so that it is difficult to produce webtoons of quality that meets expectations at a certain cycle. Accordingly, efforts are being made to produce cartoons using generative artificial intelligence models. However, generative artificial intelligence models only output randomly generated images and do not generate consistent images, so it is difficult to keep the essential condition of comics, which is to create consistent images that fit the artist's style.

Accordingly, when generating images by using a generative artificial intelligence model, there is a need to provide a learning method for a generative artificial intelligence model to generate consistent images by reflecting the user's intention.

### SUMMARY

Embodiments of the inventive concept provide a learning method and device for a generative artificial intelligence model that enable the generative artificial intelligence model to generate output data with consistent characteristics as intended by the user when the generative artificial intelligence model outputs the output data.

Objects of the inventive concept may not be limited to the above, and other objects will be clearly understandable to those having ordinary skill in the art from the following disclosures.

According to an embodiment, a learning method of a generative artificial intelligence model executed by a processor of a server includes collecting original data of an artist; preparing valid data by removing noise from the original data; performing a first style learning operation of distinguishing and learning color information and line information among the valid data; and generating a first bias model by merging training data derived from the first style learning operation again.

In an embodiment, the valid data may include a tag indicating an image included in the valid data.

In an embodiment, the performing of the first style learning operation may include distinguishing coloring data corresponding to the color information and line drawing data corresponding to the line information among the valid data; and deriving training data by individually learning each of the coloring data and the line drawing data.

In an embodiment, the distinguishing of the coloring data and the line drawing data may further include extracting at least one of the coloring data and the line drawing data from the valid data.

In an embodiment, the generating of the first bias model may include generating the first bias model by merging first training data calculated by learning the coloring data and second training data calculated by learning the line drawing data.

In an embodiment, the merging of the first training data and the second training data may include assigning a first weight to the first training data; assigning a second weight to the second training data; and merging the first training data and the second training data to which each weight is assigned.

In an embodiment, the learning method may further include performing a second style learning operation of selectively learning only data including background information among the valid data; and generating a second bias model based on training data derived from the second style learning operation.

In an embodiment, the performing of the second style learning operation may include securing background data corresponding to the background information from the valid data; and learning the background data.

In an embodiment, the learning method may further include merging the first bias model and the second bias model.

In an embodiment, the learning method may further include performing a third style learning operation of selectively learning only data including person information among the valid data; and generating a third bias model based on training data derived through the third style learning operation.

In an embodiment, the performing of the third style leaning operation may include securing person data corresponding to the person information from the valid data; and learning the person data.

In an embodiment, the learning method may further include selecting an engine based on similarity to the original data of the artist; testing the first to third bias models by using the selected engine; and generating a fourth bias model by using the tested first to third bias models and the engine.

In an embodiment, the testing of the first to third bias models may include generating a plurality of result images by using the selected engine and the first to third bias models; and comparing the plurality of resulting images with the original data of the artist.

In an embodiment, the generating of the plurality of result images may include generating the plurality of result images with the selected engine by using a merge model obtained by merging the first bias model and the second bias model and the third bias model at a preset ratio.

In an embodiment, the comparing of the plurality of result images and the origin data may include calculating a similarity between the original data and the plurality of result images.

In an embodiment, the learning method may further include adjusting each weight assigned to the training data when the similarity is less than a preset value; selecting only a result image whose similarity is greater than or equal to the preset value from the plurality of result images; generating additional training data by using the selected result image; merging the additional training data into at least one of the merge model and the third bias model; and retesting the modified merge model by using the selected engine.

In an embodiment, the generating of the fourth bias model may include merging the merge model and the third bias model into the engine when the similarity is greater than or equal to the preset value.

According to an embodiment, there is provided a computer-readable storage medium storing a computer program for executing a method of learning a generative artificial intelligence model, wherein, when executed by a processor of a device, the computer program is configured to cause the processor of the device to perform operations of training the generative artificial intelligence model, wherein the operations includes collecting original data of an artist; preparing valid data by removing noise from the original data; performing a first style learning operation of distinguishing and learning color information and line information among the valid data; and generating a first bias model by merging training data derived from the first style learning operation again.

According to an embodiment, a device for training a generative artificial intelligence model includes a storage unit that stores at least one program command; and a processor that executes the at least one program command, wherein the processor may collect original data of an artist; prepare valid data by removing noise from the original data; perform a first style learning operation of distinguishing and learning color information and line information among the valid data; and generate a first bias model by merging training data derived from the first style learning operation again.

The various examples of the inventive concept described above are only some of the preferred examples of the inventive concept, and various examples in which the technical features of various examples of the inventive concept are reflected may be derived and understood by those of ordinary skill in the art, based on the detailed description to be given.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a diagram illustrating an exemplary network environment related to a generative artificial intelligence model learning system according to embodiments of the inventive concept;

FIG. 2 is a block diagram illustrating an embodiment of the configuration of a device that constitutes a system for training a generative artificial intelligence model;

FIG. 3 is a flowchart illustrating an example of a method of training a generative artificial intelligence model according to embodiments of the inventive concept;

FIG. 4 is a flowchart illustrating an example of a first style learning operation and a first bias model generating operation according to embodiments of the inventive concept; and

FIG. 5 is a flowchart illustrating an example of a testing operation and a fourth bias model generating operation according to embodiments of the inventive concept.

### DETAILED DESCRIPTION

Because the embodiments of the present disclosure may be variously modified and have various forms, specific embodiments are illustrated in the drawings and described in detail in following descriptions. However, it should be understood that this is not intended to limit the present disclosure to specific disclosed forms, and includes all modifications, equivalents, and substitutes included in the spirit and scope of the present disclosure.

The terms first, second, etc. may be used to describe various elements, but the elements should not be limited by the terms. The terms may be referred to as a second component only for the purpose of distinguishing one component from another component, for example without departing from the scope of the right according to the concept of the inventive concept. Similarly, the second component may also be referred to as a first component. The term and/or includes any of a plurality of related stated items or a combination of a plurality of related stated items.

Singular forms are intended to include plural forms unless the context clearly indicates otherwise. That is, unless otherwise specified or clear from context to indicate a singular form, the singular in this disclosure and claims should generally be construed to mean “one or more”.

It should be understood that a constituent element, when referred to as being “connected to” or “coupled to” another constituent element, may be directly connected or directly coupled to another constituent element or may be coupled or connected to another constituent element with a third constituent element disposed therebetween. In contrast, it should be understood that a constituent element, when referred to as being “directly coupled to” or “directly connected to” another constituent element, is coupled or connected to another constituent element without a third constituent element therebetween.

Terms used in this disclosure are used to describe specified embodiments of the inventive concept and are not intended to limit the scope of the inventive concept. Singular forms are intended to include plural forms unless the context clearly indicates otherwise. In the present disclosure, terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

As used in this disclosure, the terms “information” and “data” may be used interchangeably. Likewise, the terms “picture” and “image” used in this disclosure may be used interchangeably. The term “content” used in this disclosure refers to various information or contents provided through the Internet or computer communication, and may include pictures, images, videos, texts, and the like.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the inventive concept will be described in detail with reference to the accompanying drawings. In order to facilitate overall understanding when describing the inventive concept, the same reference numerals are used for the same components in the drawings, and duplicate descriptions of the same components are omitted.

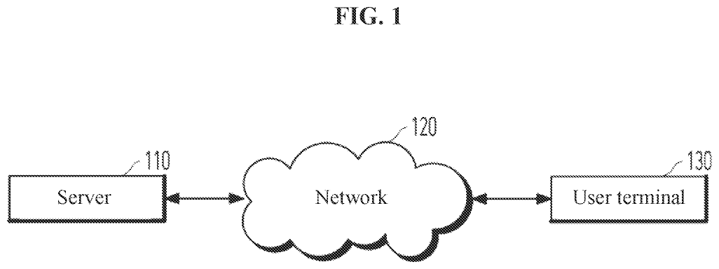

FIG. 1 is a diagram illustrating an exemplary network environment related to a generative artificial intelligence model learning system according to embodiments of the inventive concept.

Referring to FIG. 1, a generative artificial intelligence model learning system may include a server 110 and a user terminal 130 connected to the server 110 through a network 120.

The network 120 may refer to a connection structure for exchanging information between the server 110 and the user terminal 130. The network 120 may include the Internet, a local area network (LAN), a wireless LAN, a wide area network (WAN), a personal area network (PAN), 3G, 4G, long term evolution (LTE), voice over LTE (VOLTE), 5G new radio (NR) wireless-fidelity (Wi-Fi), Bluetooth, NFC, radio frequency identification (RFID), home network, Internet of things (IoT), and the like.

The server 110 may include an artificial intelligence module including a generative artificial intelligence model. A generative artificial intelligence model refers to artificial intelligence that generates results according to the specific needs of a user. Accordingly, when a user of the server 110 inputs a command to the server 110, the server 110 may generate content corresponding to the command. For example, when a user inputs a command of “Generate a picture of a woman walking on a road” to the server 110, the server 110 may generate a picture of a woman walking on a road.

In addition, the server 110 can train a generative artificial intelligence model. In detail, the server 110 may train a generative artificial intelligence model or a sub-model of the generative artificial intelligence model. In this case, the generative artificial intelligence model refers to an essential model when creating content. The sub-model of the generative artificial intelligence model is not an essential model when creating content, but the sub-model of the generative artificial intelligence model refers to a model that assists the generative artificial intelligence model when creating content. In an embodiment of the inventive concept, the server 110 may reinforce the generative artificial intelligence model through the sub-model and generate content with consistent characteristics that reflect the user's intention.

In addition, the sub-model of the generative artificial intelligence model may include input data, which is basic data provided to obtain an output from the server, an input tool that interacts with the generative artificial intelligence model, and a weight adjustment tool.

In detail, the sub-model of the generative artificial intelligence model may include a command (input data) input by a user or a bias model that interacts with the generative artificial intelligence model to generate content according to the command input by the user. In an embodiment, a bias model may be an input tool that is input along with input data to influence a weight of the generative artificial intelligence model. In another embodiment, the bias model may be one layer within a generative artificial intelligence model. Hereinafter, it is assumed that the generative artificial intelligence model includes a generative artificial intelligence model and a sub-model of the generative artificial intelligence model.

The server 110 may continuously train the generative artificial intelligence model to optimize the content generated by the generative artificial intelligence model to the user's intention, and test the trained model. In addition, the server 110 may store in advance an algorithm for training a generative artificial intelligence model.

The user terminal 130 may be connected to the server 110 through the network 120. The user terminal 130 may include user equipment such as a computer, a tablet, or a smartphone. The user terminal 130 may receive content desired by the user through the server 110. The user terminal 130 may display content generated through the server 110 through an output device.

The server 110 and the user terminal 130 of FIG. 1 may be referred to as devices, and the configurations of the devices may be as described below.

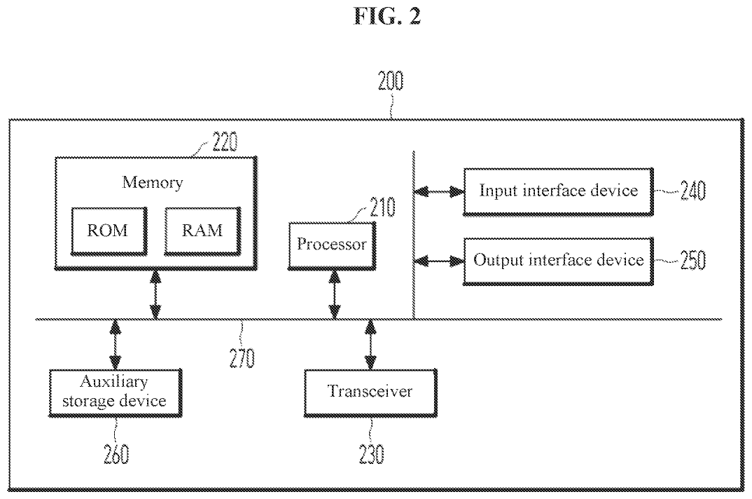

FIG. 2 is a block diagram illustrating an embodiment of the configuration of a device that constitutes a system for training a generative artificial intelligence model.

A device 200 included in a system may include a memory 220 for storing at least one program command and at least one processor 210 for performing at least one program command.

In this case, the at least one processor 210 may refer to a central processing unit (CPU), a graphics processing unit (GPU), or a dedicated processor on which methods according to embodiments of the inventive concept are performed. Each of the memory 220 and an auxiliary storage device 260 may be composed of at least one of a volatile storage medium and a non-volatile storage medium. For example, the memory 220 may be composed of at least one of a read only memory (ROM) and a random access memory (RAM).

In addition, the device 200 included in the system may include a transceiver 230 that communicates through a wireless network. In addition, the device 200 included in the system may further include an input interface device 240, an output interface device 250, the auxiliary storage device 260, and the like. Components included in the device 200 may be connected through a bus 270 to communicate with each other.

The algorithms and operations executed by a server of a system for training a generative artificial intelligence model may be as described below.

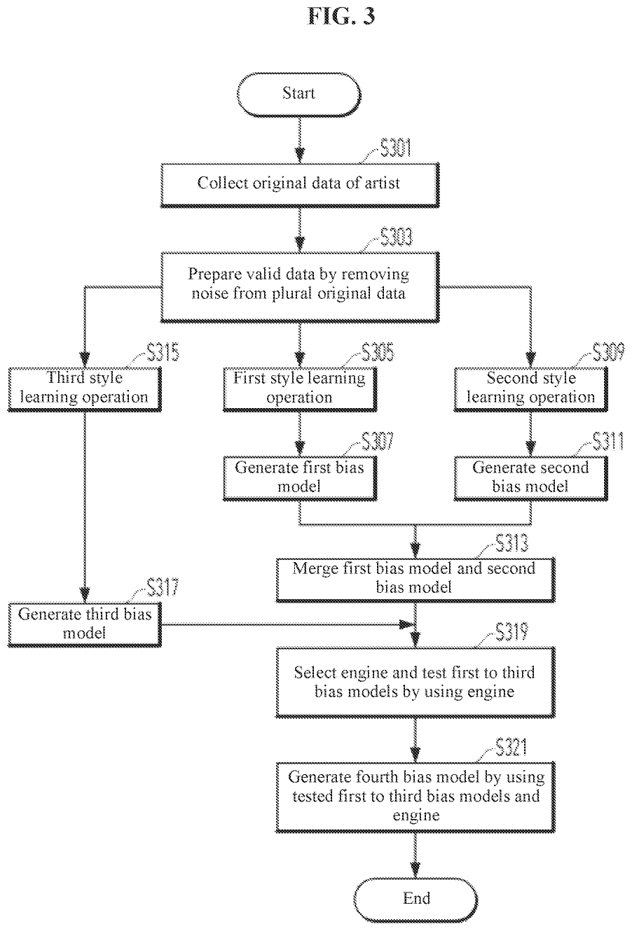

FIG. 3 is a flowchart illustrating an example of a method of training a generative artificial intelligence model according to embodiments of the inventive concept.

In operation S301, a server may collect original data of an artist. Hereinafter, an artist means a person who paints pictures professionally. Additionally, the original data of an artist refers to data that includes pictures drawn by the artist himself. The server may secure the artist's original data by receiving the original data from the artist or collecting the artist's original data from the web.

In this case, the server may collect a preset amount of the artist's original data. For example, the preset amount may be about 100 or more. In other words, the server may collect about 100 or more paintings drawn by the artist himself. However, the embodiment is not limited to thereto.

In operation S303, the server may prepare valid data by removing noise from a plurality of original data. In detail, the server may remove original data including noise from among the plurality of original data, or remove noise from original data including the noise. In this case, noise may mean an element that interferes with learning. For example, it may mean light special effects and blur processing effects that the artist includes in the picture.

Valid data may include at least one tag indicating an image included in the valid data. That is, when preparing valid data, a tag corresponding to the valid data may be set. The tag may refer to one or more natural words that refer to an image. In this case, natural words may include various languages.

For example, when an image included in valid data is a picture of a woman walking on a road, the valid data may include tags of “woman”, “on a road”, and “walking”, corresponding to the image. By setting tags to corresponding images, the server may more quickly learn what information the image contains and apply it accurately.

In operation S305, the server may perform a first style learning operation of distinguishing and learning color information and line information among valid data. The first style learning operation may refer to an artist's painting style learning operation.

In operation S307, the server may generate a first bias model by using training data derived in the first style learning operation. The first bias model generated in the first style learning operation may be a tool for generating an image that focus on the characteristics of the artist's painting style. In detail, the first style learning operation and the first bias model generating operation may be as described below.

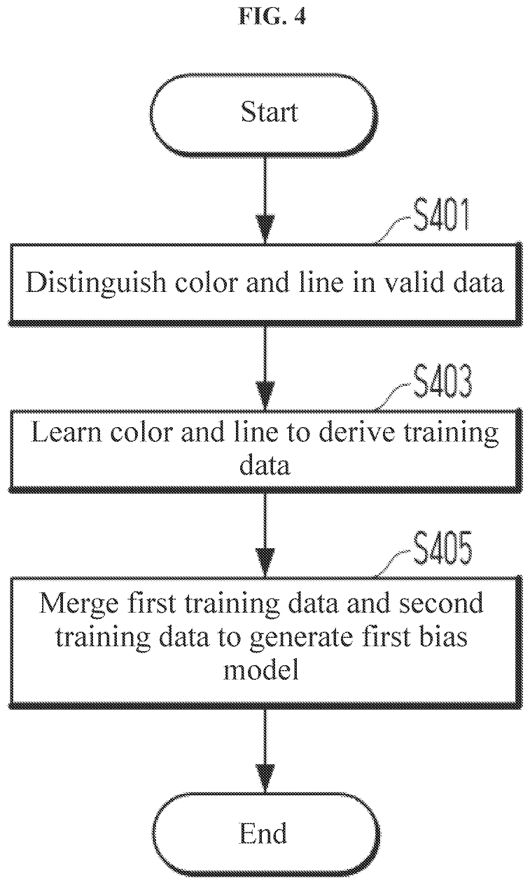

FIG. 4 is a flowchart illustrating an example of a first style learning operation and a first bias model generating operation according to embodiments of the inventive concept.

Referring to FIG. 4, in operation S401, the server may distinguish coloring data corresponding to color information and line drawing data corresponding to line information among valid data.

In an embodiment, the server may collect coloring data corresponding to color information and line drawing data corresponding to line information separately from the valid data. In another embodiment, in the valid data, coloring data corresponding to a colored image may be distinguished from line drawing data corresponding to an image in which only line drawings exist without coloring. In still another embodiment, the server may distinguish between coloring data corresponding to a color image and line drawing data corresponding to a black-and-white image in the valid data.

In still another embodiment, the server may extract and collect at least one of coloring data and line drawing data from the valid data. For example, when the quantity of line drawing data is smaller than the quantity of coloring data, the server may extract the line drawing data from the valid data. Accordingly, the server may secure more quantity of line drawing data.

In operation S403, the server may derive training data by individually learning the coloring data and the line drawing data. That is, the server may individually derive first training data calculated by learning the coloring data and second training data calculated by learning the line drawing data.

In operation S405, the server may merge the training data (first training data and second training data) derived through the first style learning operation again to generate a first bias model. That is, the server may generate the first bias model by merging the first training data and the second training data.

When the server merges the first training data and the second training data, the server may assign a first weight to the first training data and a second weight to the second training data. The server may set weights to the coloring data and the line drawing data according to respective importance, respectively. The server may merge the first training data and the second training data to which each weight is assigned. Through the weights, the server may set which information to give more weight to when the generative artificial intelligence model creates content. That is, even though the first bias model is generated using the same training data, the first bias models different from each other may be generated depending on the first weight and the second weight.

In addition, in the first style learning operation, the server may learn information other than color information and line information among the valid data while distinguishing it. For example, the server may distinguish and learn color information, line information, and post-processing information among the valid data. In this case, the post-processing information may mean information included as a background effect in a picture drawn by an artist. That is, the server may distinguish effect data corresponding to coloring data, line drawing data, and post-processing information among valid data. In addition, the server may derive training data by individually learning coloring data, line drawing data, and effect data. As a result, the server may merge the third training data obtained by learning the first training data, the second training data, and the effect data derived in the first style learning operation, thereby generating the first bias model.

In an embodiment, in the first style learning operation, the server may distinguish at least two pieces of information including the color information and the line information in the valid data, such that the server distinguishes and learns data corresponding to each piece of information. In this case, the server may learn the characteristics of each piece of information more accurately than when learning all information. Therefore, when the server generates content by using the trained generative artificial intelligence model, images reflecting the artist's characteristics (e.g., painting style) may be created.

Referring again to FIG. 3, in operation S309, the server may perform a second style learning operation of selectively learning only data including background information among the valid data. The server may secure background data corresponding to background information from valid data and learn the secured background data.

In this case, the background information may mean information on a part of an artist's painting included in the valid data that is not directly drawn by the artist. In other words, the background information may refer to information on parts of an artist's painting included in the valid data that do not reflect the artist's unique painting style. For example, background information may refer to parts of an artist's painting that the artist do not draw directly but included as an object or background by processing a photo or 3D image. Therefore, the second style learning stage may refer to the background style learning operation included in artist's drawings although the artist does not draw them directly.

The server may learn by extracting only the background information from the valid data. Alternatively, the server may selectively learn only valid data including background information among the valid data.

In operation S311, the server may generate a second bias model based on the training data derived through the second style learning operation. The second bias model generated in the second style learning operation may be a tool for generating an image that focuses on the background characteristics of the artist's painting included in the valid data.

In operation S313, the server may merge the first bias model and the second bias model. That is, the server may generate a merge model by merging the first bias model and the second bias model. In this case, the server may merge the first bias model and the second bias model after assigning weights to the first bias model and the second bias model, respectively. That is, the server may set weights to the first bias model for the artist's style and the second bias model for backgrounds other than the artist's style according to their respective importance. Accordingly, when generating content, the server may set whether to place more emphasis on the style or background. That is, even though the same first bias model and second bias model are used to merge, different first bias models may be generated depending on the weight.

In operation S315, the server may perform a third style learning operation of selectively learning only data including person information among the valid data. The server may secure person data corresponding to person information from the valid data and learn the secured person data.

In this case, the person information may mean information on a part corresponding to a character (e.g., dramatis personae) in the artist's painting included in the valid data. For example, characters may refer to people, animals, and objects that mainly appear in the artist's painting included in the valid data. Therefore, the third style learning operation may refer to a character style learning operation included in the artist's painting included in the valid data.

The server may extract only the person information from the valid data to learn the person information. Alternatively, the server may selectively learn only data including personal information among from the valid data.

In addition, the server may distinguish and collect gender data corresponding to gender information and clothing data corresponding to clothing information among the person information in the valid data. For example, the server can extract and collect gender data and clothing data from valid data. The server can derive training data by individually learning gender data and clothing data.

In operation S317, the server may generate a third bias model based on the training data derived through the third style learning operation. The third bias model generated through the third style learning operation may be a tool for generating an image that focus on the characteristics of a character in the artist's painting included in the valid data.

In this case, the server may individually learn the gender data and clothing data and merge the derived training data again to generate the third bias model. However, the embodiment of the inventive concept is not limited thereto, and the server may learn the gender data and clothing data from person information in an integrated manner rather than learning them individually.

In an embodiment, the server may generate a bias model by individually learning the painting style, character, and background information from the artist's paintings included in the valid data in the first to third style learning operations, so that the server may distinguish and learn the data corresponding to information. Thus, the server may learn the characteristics of each piece of information more accurately than when learning all information together. In addition, when creating content using the first to third bias models, the user may determine which information to focus on among the style, character, and background to create the content, and receive the content by requesting the content from the server accordingly. Therefore, when the server generates content by using a bias tool, which is a generative artificial intelligence model, images reflecting the artist's characteristics (e.g., the artist's style, characters, and background) may be generated as the user intends.

In operation S319, the server may select an engine based on similarity to the writer's original data. In this case, the engine may be a generative artificial intelligence model or sub-model that already exists on the server. The server may select an engine that generates an image similar to the artist's original data from various engines. In other words, the server may measure the similarity between the image generated using the engine and the original data. In this case, when the similarity is greater than a preset reference value, the server may select the corresponding engine. For example, the preset reference value may be about 70% or more. Preferably, the server may select the engine with the highest similarity between the image generated using the engine and the original data.

In addition, the server may test the first to third bias models by using the selected engine. The server may improve the completeness of the bias models by testing the first to third bias models.

In operation S321, the server may generate a fourth bias model by using the tested first to third bias models and the selected engine. The fourth bias model generated in such a manner may generate content as a generative artificial intelligence model. In detail, the fourth bias model may be a generative artificial intelligence model, and each of the first to third bias models may be a sub-model of the generative artificial intelligence model. However, the embodiments of the inventive concept are not limited thereto.

In detail, the operation of testing the first to third bias models and the operation of generating the fourth bias model may be as described below.

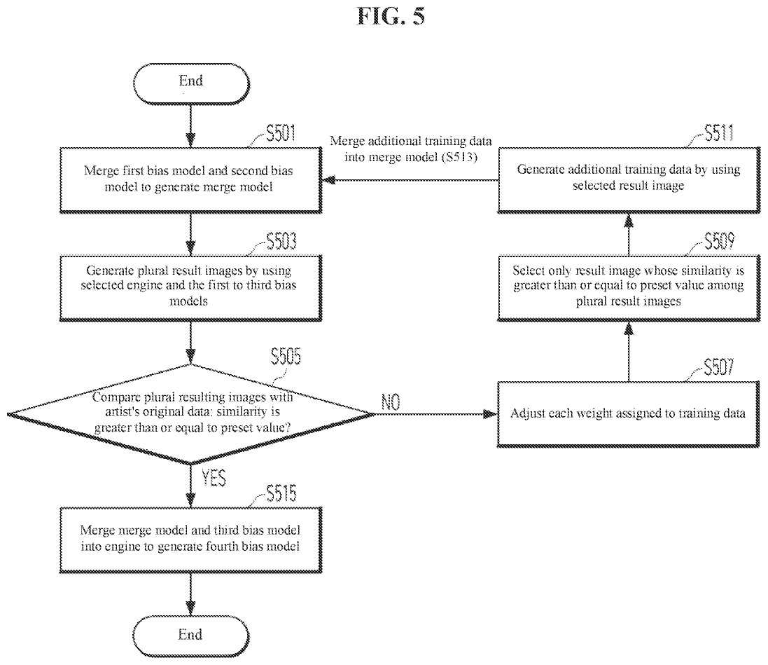

FIG. 5 is a flowchart illustrating an example of a testing operation and a fourth bias model generating operation according to embodiments of the inventive concept.

Referring to FIG. 5, in operation S501, the server may merge the first bias model and the second bias model to generate a merge model.

In operation S503, the server may generate a plurality of result images by using the engine selected based on the artist's similarity and the first to third bias models. In detail, the server may generate the plurality of result images by using the engine selected by using the merge model and the third bias model at a preset ratio. Preferably, the preset ratio may be a ratio of the merge model to the third bias model=1:0.2. However, the embodiments of the inventive concept are not limited thereto.

In this case, using the merge model and the third bias model at the preset ratio does not mean merging the merge model and the third bias model, but rather means using the merge model and the third bias model together at the preset ratio. As the server uses the merge model and the third bias model together without merging, the server may allow character information (i.e., characters) to be expressed more prominently than other information (e.g., painting style and background) in content generated using the learned generative artificial intelligence model. However, the embodiments of the inventive concept are not limited thereto, and in another embodiment, the server may use each of the first to third bias models at a preset ratio. In still another embodiment, the server may use the first to third bias models by merging the first to third bias models according to weights.

In operation S505, the server may compare the plurality of resulting images with the artist's original data. That is, the server may calculate the similarity between the artist's original data and all of the plurality of resulting images.

In operation S507, when the similarity is less than a preset value, the server may adjust each weight assigned to the training data. That is, the server may adjust the weights given to the first training data and the second training data, respectively when generating the first bias model, and the weights given to the first bias model and the second bias model, respectively when generating the merge model. In addition, the server may also adjust the parallel use ratio for the merge model and the third bias model. The server may improve the completeness of the resulting image by adjusting the weight or ratio.

In operation S509, the server may also select only the result images whose similarity is greater than or equal to a preset value among the plurality of result images. For example, the similarity may be about 70%. However, the embodiments of the inventive concept are not limited thereto.

In operation S511, the server may generate additional training data by using the selected result image. In operation S513, the server may retrain using only high-quality data or merge it into a merge model by generating additional training data based on the result images whose similarity is greater than or equal to a preset value among the plurality of result images.

In detail, in an embodiment, the server may reuse the selected result image as valid data. Accordingly, the server may increase the amount of valid data by including the selected result images as valid data. In addition, the completeness of bias models may be improved by retraining using only high-quality data.

In another embodiment, the server may merge additional training data into at least one of the merge model and the third bias model. That is, the server may modify the merge model or third bias model by merging additional training data generated based on a high-quality image into the merge model or third bias model. After modifying the merge model or third bias model, the server may retest the modified merge model or third bias model by using the selected engine. That is, the server may regenerate a plurality of resulting images by using the selected engine and the modified merge model or third bias model.

In this case, when the similarity is again less than a preset value, operations S507 to S513 may be repeated again. Through the process described above, the server may generate more complete first to third bias models.

In operation S515, when the similarity is greater than or equal to a preset value, the server may end testing the first to third bias models. The server may generate the fourth bias model by using the first to third bias models that have been tested and the engine. In detail, the server may merge the tested merge model and the third bias model into the engine to generate the fourth bias model. In this case, the server may assign weights to the merge model, the third bias model and the engine, respectively and merge them.

The generated fourth bias model, which is a generative artificial intelligence model, may generate consistent images that reflect the artist's characteristics.

In an embodiment, the finally generated fourth bias model may be generated by merging the first to third bias models that reflect the characteristics of the artist's picture with an engine similar to the artist's original data. Accordingly, when generating an image using the fourth bias model, the server may generate content, that is, an image, by reflecting the characteristics of the artist's painting without a relatively large amount of data.

In addition, when using the fourth bias model, the server may consistently generate images that reflect the characteristics of the artist's paintings. Accordingly, when an artist selects the fourth bias model from the server and inputs a prompt indicating the character, background, and the like the artist desires on a corresponding scene, the server may generate a completed state of an image that reflects the artist's painting style. Therefore, because the artist only has to write continuity, the time and cost required to produce content may be dramatically reduced.

When the server uses the fourth bias model, the server may receive the continuity written by an artist and output the image complete with sketching and coloring as output data. In this case, according to the artist's intention, the server may individually output an image complete with only sketching and an image complete with sketching and coloring. In addition, according to the artist's intention, after outputting an image complete with only sketching, the server may output, as output data, an image complete with sketching and coloring by using a bias model again together with the image complete with only sketching.

In conclusion, an artist may use the image complete with coloring as the final finished image. When there is something the artist desires to add or modify in the generated image, the artist may produce a final finished image by partially modifying an image complete with only sketching or an image complete with sketching and coloring. Therefore, the time and cost required to produce content for an artist may be dramatically reduced.

The methods according to the above-described exemplary embodiments of the inventive concept may be implemented with program instructions which may be executed through various computer means and may be recorded in computer-readable media. The media may also include, alone or in combination with the program instructions, data files, data structures, and the like. The program instructions recorded in the media may be designed and configured specially for the exemplary embodiments of the inventive concept or be known and available to those skilled in computer software.

Computer-readable media include hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to act as one or more software modules to perform the operations of the above-described exemplary embodiments of the inventive concept, or vice versa.

According to the embodiments of the inventive concept, in each style learning operation, a server may distinguish at least two pieces of information among valid data, so that the server may distinguish and learn data corresponding to each piece of information. Thus, the server may learn the characteristics of each piece of information more accurately than when learning all information together. Therefore, when the server generates content, images reflecting the artist's characteristics (e.g., painting style, character, and background information, and the like) may be generated.

When using the finally generated bias model, the server may consistently generate images that reflect the characteristics of the artist's paintings. Accordingly, when an artist selects a bias model from the server and inputs a prompt indicating the character, background, and the like the artist desires on a corresponding scene, the server may generate a complete state of an image that reflects the artist's painting style. Therefore, because the artist only has to write a prompt, the time and cost required to produce content may be dramatically reduced.

Effects obtained by various embodiments of the inventive concept may not be limited to the above, and other effects will be clearly understandable to those having ordinary skill in the art from the inventive concept.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A learning method of a generative artificial intelligence model executed by a processor of a server; the learning method comprising:
collecting original data of an artist;
preparing valid data by removing noise from the original data;
performing a first style learning operation of distinguishing and learning color information and line information among the valid data; and
generating a first bias model by merging training data derived from the first style learning operation again.

2. The learning method of claim 1, wherein the valid data includes a tag indicating an image included in the valid data.

3. The learning method of claim 1, wherein the performing of the first style learning operation includes:
distinguishing coloring data corresponding to the color information and line drawing data corresponding to the line information among the valid data; and
deriving training data by individually learning each of the coloring data and the line drawing data.

4. The learning method of claim 3, wherein the distinguishing of the coloring data and the line drawing data further includes extracting at least one of the coloring data and the line drawing data from the valid data.

5. The learning method of claim 3, wherein the generating of the first bias model includes generating the first bias model by merging first training data calculated by learning the coloring data and second training data calculated by learning the line drawing data.

6. The learning method of claim 5, wherein the merging of the first training data and the second training data includes:
assigning a first weight to the first training data;
assigning a second weight to the second training data; and
merging the first training data and the second training data to which each weight is assigned.

7. The learning method of claim 6, further comprising:
performing a second style learning operation of selectively learning only data including background information among the valid data; and
generating a second bias model based on training data derived from the second style learning operation.

8. The learning method of claim 7, wherein the performing of the second style learning operation includes:
securing background data corresponding to the background information from the valid data; and
learning the background data.

9. The learning method of claim 8, further comprising:
merging the first bias model and the second bias model.

10. The learning method of claim 9, further comprising:
performing a third style learning operation of selectively learning only data including person information among the valid data; and
generating a third bias model based on training data derived through the third style learning operation.

11. The learning method of claim 10, wherein the performing of the third style learning operation includes:
securing person data corresponding to the person information from the valid data; and
learning the person data.

12. The learning method of claim 11, further comprising:
selecting an engine based on similarity to the original data of the artist;
testing the first to third bias models by using the selected engine; and
generating a fourth bias model by using the tested first to third bias models and the engine.

13. The learning method of claim 12, wherein the testing of the first to third bias models includes:
generating a plurality of result images by using the selected engine and the first to third bias models; and
comparing the plurality of resulting images with the original data of the artist.

14. The learning method of claim 13, wherein the generating of the plurality of result images includes:
generating the plurality of result images with the selected engine by using a merge model obtained by merging the first bias model and the second bias model and the third bias model at a preset ratio.

15. The learning method of claim 14, wherein the comparing of the plurality of result images and the origin data includes:
calculating a similarity between the original data and the plurality of result images.

16. The learning method of claim 15, further comprising:
adjusting each weight assigned to the training data when the similarity is less than a preset value;
selecting only a result image whose similarity is greater than or equal to the preset value from the plurality of result images;
generating additional training data by using the selected result image;
merging the additional training data into at least one of the merge model and the third bias model; and
retesting the modified merge model by using the selected engine.

17. The learning method of claim 16, wherein the generating of the fourth bias model includes merging the merge model and the third bias model into the engine when the similarity is greater than or equal to the preset value.

18. A computer-readable storage medium storing a computer program for executing a method of learning a generative artificial intelligence model,
wherein, when executed by a processor of a device, the computer program is configured to cause the processor of the device to perform operations of training the generative artificial intelligence model, wherein the operations includes:
collecting original data of an artist;
preparing valid data by removing noise from the original data;
performing a first style learning operation of distinguishing and learning color information and line information among the valid data; and
generating a first bias model by merging training data derived from the first style learning operation again.

19. A device for training a generative artificial intelligence model, the device comprising:
a storage unit configured to store at least one program command; and
a processor configured to execute the at least one program command,
wherein the processor is configured to:
collect original data of an artist;
prepare valid data by removing noise from the original data;
perform a first style learning operation of distinguishing and learning color information and line information among the valid data; and
generate a first bias model by merging training data derived from the first style learning operation again.
